(19) United States
(12) Patent Application Publication
(10) Pub. No.: US 2025/0024095 A1
(43) Pub. Date: Jan. 16, 2025

(54) SIGNALING POSE METADATA FOR SPLIT RENDERING OF EXTENDED REALITY MEDIA DATA

(71) Applicant: QUALCOMM Incorporated, San Diego, CA (US)

(72) Inventors: Imed Bouazizi, Celina, TX (US); Thomas Stockhammer, Bergen (DE); Liangping Ma, San Diego, CA (US); Nikolai Konrad Leung, San Francisco, CA (US)

(21) Appl. No.: 18/741,312

(22) Filed: Jun. 12, 2024

Related U.S. Application Data
(60) Provisional application No. 63/513,012, filed on Jul. 11, 2023.

(51) Int. Cl. H04N 21/435; H04N 21/81; H04N 21/8358; H04N 21/8547

(52) U.S. Cl. CPC H04N 21/435; H04N 21/816; H04N 21/8358; H04N 21/8547

(57) ABSTRACT

An example device for retrieving media data includes a memory configured to store media data; and a processing system comprising one or more processors implemented in circuitry, the processing system being configured to execute a media application, and configured to execute a streaming unit to: receive a rendered frame of media data from a source device in a media stream; receive system metadata to be passed to the media application, wherein the metadata is included in the media stream; and provide the rendered frame and the system metadata to the media application.

This application claims the benefit of U.S. Provisional Application No. 63/513,012, filed Jul. 11, 2023, the entire contents of which are hereby incorporated by reference.

### TECHNICAL FIELD

This disclosure relates to storage and transport of encoded media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After video data and other media data have been encoded, the media data may be packetized for transmission or storage. The media data may be assembled into a video file conforming to any of a variety of standards, such as the International Organization for Standardization (ISO) base media file format and extensions thereof.

### SUMMARY

In general, this disclosure describes techniques related to split rendering of extended reality (XR) media data. In particular, when split rendering media data, two or more devices may be involved in rendering the media data. For example, a source device (e.g., a server device) and a client device may each perform at least part of the rendering process. The client device may indicate, to the server device, a current pose of a user (e.g., relative position and viewing orientation/rotation), as well as movement information of the user. The server device may use this information to determine an estimated pose of the user at the time a frame will be presented to the user, and render the frame according to the estimated pose. The server device may add system metadata to the media stream, where the system metadata represents data to be passed from a streaming unit (which transports media data) to a media application that, e.g., plays the media data.

For example, the system metadata may include the pose data indicating the pose for which a media frame was rendered. The client device may modify the rendered frame as part of a rendering process performed by the client, as well as pose differences between the estimated pose and the actual pose of the user at the time the frame is to be presented. According to the techniques of this disclosure, the server device may signal metadata representative of the estimated pose to the client device in the system metadata, i.e., data included in the bitstream that also includes the rendered frame, as opposed to in header data that encapsulates packets of the bitstream (e.g., RTP headers or header extensions).

In one example, a method of retrieving media data includes: receiving, by a streaming unit of a client device that also executes a media application, a rendered frame of media data from a source device in a media stream; receiving, by the streaming unit of the client device, system metadata to be passed to the media application, wherein the metadata is included in the media stream; and providing, by the streaming unit of the client device, the rendered frame and the system metadata to the media application.

In another example, a device for retrieving media data includes: a memory configured to store media data; and a processing system comprising one or more processors implemented in circuitry, the processing system being configured to execute a media application, and configured to execute a streaming unit to: receive a rendered frame of media data from a source device in a media stream; receive system metadata to be passed to the media application, wherein the metadata is included in the media stream; and provide the rendered frame and the system metadata to the media application.

In another example, a method of rendering media data includes: receiving, by a source device, data representing a user pose for which to render media data from a client device; rendering, by the source device, a rendered frame of media data according to the user pose; generating, by the source device, system metadata to be passed to a media application, the system metadata including pose data representing the user pose; and sending, by the source device, a media stream including the rendered frame and the metadata to the client device.

In another example, a device for rendering media data includes: a memory configured to store media data; and a processing system comprising one or more processors implemented in circuitry, the processing system being configured to: receive data representing a user pose for which to render media data from a client device; render a rendered frame of media data according to the user pose; generate system metadata to be passed to a media application, the system metadata including pose data representing the user pose; and send a media stream including the rendered frame and the metadata to the client device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing system that may perform techniques of this disclosure.

FIG. 2 is a flowchart illustrating an example method of rendering media data according to techniques of this disclosure.

FIG. 3 is a call flow diagram illustrating an example of split rendering that may be performed by the system of FIG. 1.

FIG. 4-6 are conceptual diagrams illustrating an example lifecycle of an application that uses OpenXR for interaction and rendering with/to an HMD.

### DETAILED DESCRIPTION

Extended reality (XR) generally refers to media data that partially or fully immerses a user in a virtual environment. For example, XR may include augmented reality (AR), mixed reality (MR), or virtual reality (VR). XR experiences may be shared between two or more human users who can participate in the same shared virtual environment, e.g., for a virtual teleconference, video gaming, or other such experiences.

Generally, XR audio and video data is rendered based on a user pose. That is, a user may be positioned in the virtual environment at a particular location, and the user's head may be oriented in a particular direction. Therefore, audio and video data may be rendered based on the user's specific pose.

In some circumstances, audio and/or video data may be rendered by a remote device, such as an edge server device or other cloud computing device, or a computing device separate from a head mounted display (HMD) or other collocated computing device configured to present media data to a user. For example, the HMD or other presentation device may determine a current pose and, based on a user's current position, velocity, and rotation, predict a future pose. The HMD may send data representative of the predicted pose to the rendering device, which may render media data for the predicted pose. Per the techniques of this disclosure, the rendering device may send system metadata along with rendered media data to the HMD (or other client/presentation device). The system metadata may generally represent data that is to be provided to a media application along with the media data itself, such as the pose data for which the media data was rendered. In this manner, the media application may determine an actual pose at the time at which the media data is to be presented, then modify the media data based on differences between the predicted pose and the actual pose.

While pose data is one example of system metadata that may be provided in the media stream along with media data, other examples of system metadata, in addition or in the alternative to pose data, includes perception data, environmental data, or other data used to render the media data. For example, perception data may refer to data that was perceived by sensors of the HMD, environmental data may refer to data representative of a user environment such as anchor points, and so on.

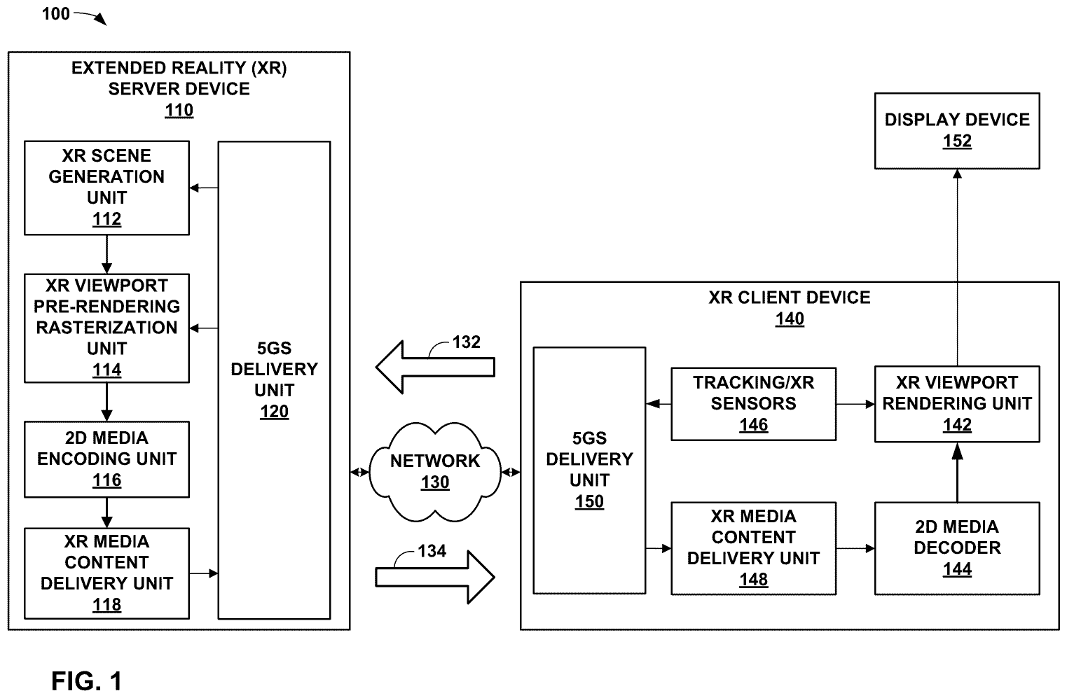

FIG. 1 is a block diagram illustrating an example computing system 100 that may perform techniques of this disclosure. In this example, computing system 100 includes extended reality (XR) server device 110, network 130, XR client device 140, and display device 152. XR server device 110 includes XR scene generation unit 112, XR viewport pre-rendering rasterization unit 114, 2D media encoding unit 116, XR media content delivery unit 118, and 5G System (5GS) delivery unit 120. Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. XR client device 140 includes 5GS delivery unit 150, tracking/XR sensors 146, XR viewport rendering unit 142, 2D media decoder 144, and XR media content delivery unit 148. XR client device 140 also interfaces with display device 152 to present XR media data to a user (not shown).

XR media content delivery unit 148 and 5GS delivery unit 150 may be referred to as a streaming unit, alone or in combination. In general, a “streaming unit” per this disclosure is configured to transport (e.g., request and receive) media data, such as XR media data. The streaming unit may be implemented as a hardware unit, a software application, or a combination thereof. When implemented in software, the streaming unit may further include one or more storage devices for storing software instructions and processing circuitry configured to execute the software instructions. The streaming unit may be separate from a media application, configured to perform media data playback. The media application (which may include 2D media decoder 144 and/or XR viewport rendering unit 142) may be configured to receive system metadata from the streaming unit and use the system metadata to render and present the media data. For example, if the system metadata includes pose information for the media data, the media application may warp the rendered data according to an actual pose at the time of presentation of the media data.

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

As discussed in greater detail below, XR server device 110 and XR client device 140 may be configured to perform split rendering of XR data. In general, split rendering involves delegating all or part of the rendering process to a device in a network/edge, such as XR server device 110, where the rendering process can be performed on a machine with high processing and graphics capabilities. To perform split rendering, XR server device 110 may require data representing a pose of a user of XR client device 140 in order to render the media, e.g., to properly perform pose correction.

In some conventional techniques, a description of a render pose may be provided in a Real-Time Transport Protocol (RTP) header extension. However, this disclosure recognizes that an RTP header extension solution may encounter certain drawbacks. For example, the RTP header extension would need to be included in every RTP packet, which may generate significant overhead. One rendered frame may translate into hundreds of RTP packets. Thus, RTP header extension based techniques may generate hundreds of times more overhead than sending the render pose description once per frame. An RTP header extension may also be overwritten or removed by synchronization sources, such as media resource functions (MRFs) in an IP Multimedia Subsystem (IMS). Furthermore, an application server (AS) may be required to interact with the RTP stack to properly set headers for every RTP packet of an RTP bitstream.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 150. XR client device 140 provides tracking and sensor information 132 to XR server device 110 via network 130.

XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

Per techniques of this disclosure, a bitstream including encoded, pre-rendered 2D media data 134 may further include system metadata that is to be passed from 2D media decoder 144 to XR viewport rendering unit 142. For example, such system metadata may include pose data representing a user pose for which the media data was rendered, perception data, environmental data, or the like. XR scene generation unit 112 and/or XR viewport pre-rendering rasterization unit 114 may provide the system metadata to 2D media encoding unit 116, which may add the system metadata to a bitstream including encoded, pre-rendered 2D media data 134. Such system metadata may be in the form of, for example, one or more supplemental enhancement information (SEI) messages. Therefore, XR viewport rendering unit 142 may use the system metadata when presenting the media data via display device 152. For example, XR viewport rendering unit 142 may warp audio and/or video data according to an actual pose for the user, updated perception data, updated environmental data, or the like.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular 'er/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 1, the viewport may be predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

In some examples, latency from rendering video data by XR server device 110 and XR client device 140 receiving such pre-rendered video data may be in the range of 50 milliseconds (ms). Latency for XR client device 140 to provide location and position (e.g., pose) information may be lower, e.g., 20 ms, but XR server device 110 may perform asynchronous time warp to compensate for the latest pose in XR client device 140.

The following call flow is an example highlighting steps of performing these techniques:
1) XR client device 140 connects to network 130 and joins an XR application (e.g., executed by XR scene generation unit 112).
   a) XR client device 140 sends static device information and capabilities (supported decoders, viewport).
2) Based on this information, XR server device 110 sets up encoders and formats.
3) Loop:
   a) XR client device 140 collects XR pose (or a predicted XR pose) using tracking/XR sensors 146.
   b) XR client device 140 sends XR pose information, in the form of tracking and sensor information 132, to XR server device 110.
   c) XR server device 110 uses tracking and sensor information 132 to pre-render an XR viewport via XR scene generation unit 112 and XR viewport pre-rendering rasterization unit 114.
   d) 2D media encoding unit 116 encodes the XR viewport.
   e) XR media content delivery unit 118 and 5GS delivery unit 120 send the compressed media to XR client device 140, along with data representing the XR pose that the viewport was rendered for.
   f) XR client device 140 decompresses the video data using 2D media decoder 144.
   g) XR client device 140 uses the XR pose data provided with the video frame and the actual XR pose from tracking/XR sensors 146 for an improved prediction and to correct the local pose, e.g., using ATW performed by XR viewport rendering unit 142.

According to TR 26.928, clause 4.2.2, the relevant processing and delay components are summarized as follows:
User interaction delay is defined as the time duration between the moment at which a user action is initiated and the time such an action is taken into account by the content creation engine. In the context of gaming, this is the time between the moment the user interacts with the game and the moment at which the game engine processes such a player response.
Age of content is defined as the time duration between the moment a content is created and the time it is presented to the user. In the context of gaming, this is the time between the creation of a video frame by the game engine and the time at which the frame is finally presented to the player.

The roundtrip interaction delay is therefore the sum of the Age of Content and the User Interaction Delay. If part of the rendering is done on an XR server and the service produces a frame buffer as a rendering result of the state of the content, then for raster-based split rendering in cloud gaming applications, the following processes contribute to such a delay:
User Interaction Delay (Pose and other interactions)
   capture of user interaction in game client,
   delivery of user interaction to the game engine, i.e., to the server (aka network delay),
   processing of user interaction by the game engine/server,
Age of Content
   creation of one or several video buffers (e.g., one for each eye) by the game engine/server,
   encoding of the video buffers into a video stream frame,
   delivery of the video frame to the game client (a.k.a., network delay),
   decoding of the video frame by the game client,
   presentation of the video frame to the user (a.k.a., framerate delay).

As XR client device 140 applies ATW, the motion-to-photon latency requirements (of at most 20 ms) are met by internal processing of XR client device 140. What determines the network requirements for split rendering is time of pose-to-render-to-photon and the roundtrip interaction delay. According to TR 26.928, clause 4.5, the permitted downlink latency is typically 50-60 ms.

Rasterized 3D scenes available in frame buffers (see clause 4.4 of TR 26.928) are provided by XR scene generation unit 112 and need to be encoded, distributed, and decoded. According to TR 26.928, clause 4.2.1, relevant formats for frame buffers are 2 k by 2 k per eye, potentially even higher. Frame rates are expected to be at least 60 fps, potentially higher up to 90 fps. The formats of frame buffers are regular texture video signals that are then directly rendered. As the processing is graphics centric, formats beyond commonly used 4:2:0 signals and YUV signals may be considered.

In order to perform pose correction, XR viewport rendering unit 142 may need to receive metadata related to pose information representing the pose for which the media data was rendered by XR service device 110. In this manner, XR viewport rendering unit 142 may perform ATW or other pose correction adjustments to the media data based on the current pose of the user of XR client device 140. According to the techniques of this disclosure, XR server device 110 may send and XR client device 140 may receive metadata representing the pose for which the media data was rendered in the form of supplemental enhancement information (SEI) messages that are associated with an access unit (e.g., a video frame). Alternatively, in some examples, XR server device 110 may send and XR client device 140 may receive embedded metadata representing the pose information in an audio bitstream as audio metadata packets. As yet another example, XR server device 110 may send and XR client device 140 may receive embedded metadata representing the pose information in-band as audio or video watermarks that are resilient to transcoding or processing.

An example SEI message including pose information metadata is shown below in Table 1:

TABLE 1

| | Descriptor |
|---|---|
| xr_render_pose_info(payloadSize) { | |
| xrpi_actions_present | u(1) |
| xrpi_reserved | u(7) |
| xrpi_timestamp | u(64) |
| xrpi_x | f(32) |
| xrpi_y | f(32) |
| xrpi_z | f(32) |
| xrpi_rx | f(32) |
| xrpi_ry | f(32) |
| xrpi_rz | f(32) |
| xrpi_rw | f(32) |
| if (xrpi_actions_present) { | |
| actions_count | u(8) |
| for (i=0;i<xrpi_actions_present;i++) | |
| { | |
| xrpi_action_id | u(16) |
| } | |
| } | |
| } | |

Semantics for the example syntax of the SEI message of Table 1 may be as follows:
xrpi_actions_present: indicates if a list of actions is present
xrpi_timestamp: the wallclock timestamp of the render pose
xrpi_x, xrpi_y, xrpi_z: the coordinates of the position of the render pose
xrpi_rx, xrpi_ry, xrpi_rz, xrpi_rw: the components of the quaternion for the rotation of the render pose
xrpi_action_count: the number of actions that are processed prior to rendering with the current render pose
xrpi_action_id: an identifier of the action that was processed prior to rendering with the current render pose

If the metadata is provided in the form of audio metadata (e.g., according to an MPEG-H codec), XR server device 110 may provide the metadata using a new MPEG-H audio stream (MHAS) packet payload type. The type may be defined as, for example, PACTYP_XRRRENDERPOSE. The syntax and semantics may be the same as that discussed above with respect to Table 1.

In some examples, XR server device 110 may provide the metadata in the form of a watermark to XR client device 140. That is, the render pose and actions information may be embedded in the media data itself using a watermarking scheme. The watermark should be provided in a way that the watermark is not visible or audible to the user of XR client device 140, but can be extracted reliably from the source signal including the media data. The metadata may be provided for each frame.

Signaling an indication that a media stream includes embedded render pose metadata may be provided using session description protocol (SDP). XR server device 110 may send to XR client device 140 an SDP attribute, e.g., “a=metadata: ,” which may indicate the presence of the metadata or list all types of metadata that are embedded in a corresponding stream. XR client device 140 may register for metadata callbacks for streams that indicate the presence of certain types of metadata. Upon reception of the render pose metadata, 2D media decoder 144 may extract the metadata and provide the metadata to XR viewport rendering unit 142.

In this manner, the various techniques of this disclosure provide an efficient mechanism to carry XR render pose metadata embedded in the media stream. These techniques may support either or both of audio and/or video media streams. The presence of the metadata may be signaled by XR server device 110 to XR client device 140, such that XR client device 140 may register a callback to receive the embedded metadata for each frame/media unit.

The various components of XR server device 110, XR client device 140, and display device 152 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

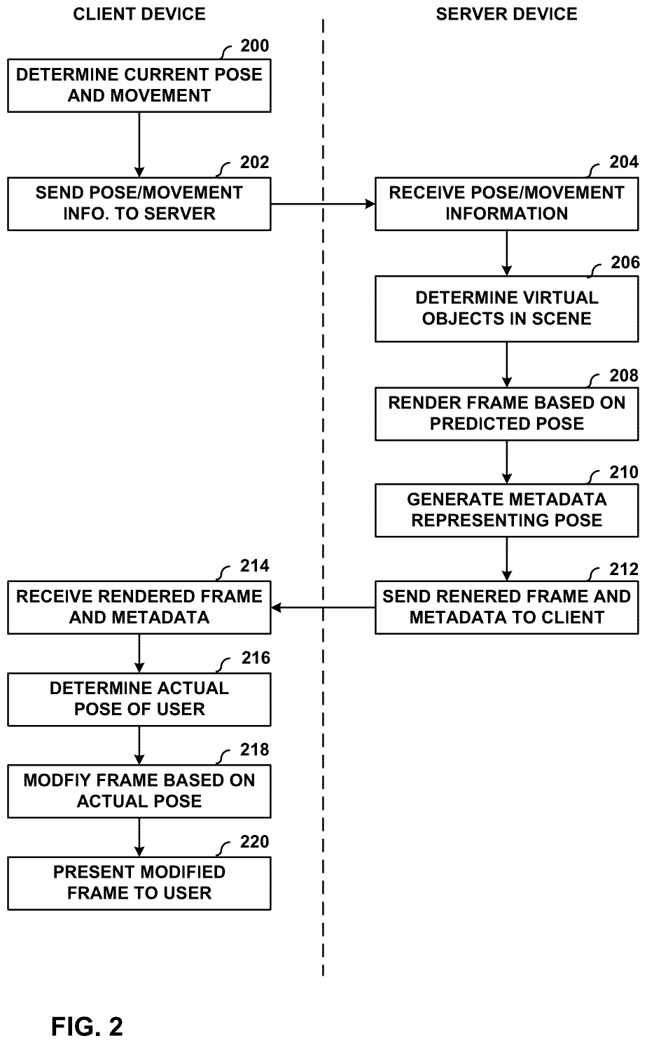

FIG. 2 is a flowchart illustrating an example method of rendering media data according to techniques of this disclosure. The method of FIG. 2 is described with respect to a client device, such as XR client device 140 of FIG. 1, and a server device, such as XR server device 110 of FIG. 1. Other devices may be configured to perform this or a similar method.

While not show in FIG. 2, initially, XR client device 140 and XR server device 110 may initiate and establish an XR communication session, e.g., for a video game, a virtual teleconference, or the like. During the XR communication session, a user of XR client device 140 may interact with a virtual scene, which may include virtual objects (e.g., walls, chairs, tables, or the like). Such interactions may include walking through the virtual scene, moving objects, talking to other users (if any), or otherwise participating in the virtual scene. Thus, the user may physically move a head-mounted display (HMD), which may include XR client device 140.

While the user is moving in actual physical space, XR client device 140 may determine a current pose and movement (200) of the user. XR client device 140 may send the current pose and movement information to XR server device 110 (202). For example, as shown in FIG. 1, XR client device 140 may send tracking and sensor information 132 to XR server device 110.

XR server device 110, in turn, may receive the pose and movement information (204). XR server device 110 may also determine virtual objects in the virtual scene (206), e.g., from a game engine, interactions from other users (if any), or the like. XR server device 110 may then render a frame based on a predicted pose of the user (208). That is, based on the pose and movement information received from XR client device 140, XR server device 110 may predict a pose of the user at the time the frame will be seen by the user, accounting for the delay between the time at which the frame is rendered by XR server device 110 and the time between XR client device 140 having sent the pose and movement information and the time at which XR client device 140 will be able to present the rendered frame.

Because the pose is predicted, according to the techniques of this disclosure, XR server device 110 may also generate system metadata, e.g., representing the predicted pose (210) for which the frame was rendered. The system metadata may additionally or alternatively include other data to be passed to a media application, such as perception data, environmental data, or the like. XR server device 110 may send the rendered frame and the system metadata to XR client device 140 (212). For example, XR server device 110 may encode the rendered frame and include the encoded frame in a bitstream. The bitstream may also include the system metadata, e.g., in the form of an SEI message, audio metadata, and/or in the form of a watermark in the rendered frame itself or in a corresponding audio frame. In this manner, the system metadata may be included in the bitstream itself, as opposed to in encapsulating header data of packets that would otherwise be removed from the packets prior to providing the packets to, e.g., a video/audio decoder and/or other media applications involved in the XR communication session.

XR client device 140 may receive the rendered frame and the system metadata (214) from XR server device 110. In the case that the system metadata represents a pose for which the media data was rendered, XR client device 140 may then determine an actual pose of the user (216) at the time the frame is to be presented. XR client device 140 may modify (e.g., warp) the frame based on differences between the predicted pose as indicated by the metadata and the actual pose of the user (218), and then present the modified frame to the user (220).

In this manner, the method of FIG. 2 represents an example of a method of rendering media data including receiving, by a client device, a rendered frame of media data from a source device in a media stream; receiving, by the client device, metadata representing a pose of a user for which the frame of media data was rendered, wherein the metadata is included in the media stream; modifying, by the client device, the rendered frame according to an actual pose of the user to form a modified rendered frame; and presenting, by the client device, the modified rendered frame to the user.

Likewise, the method of FIG. 2 represents an example of a method of rendering media data including receiving, by a source device, data representing a user pose for which to render media data from a client device; rendering, by the source device, a rendered frame of media data according to the user pose; generating, by the source device, metadata representing the user pose; and sending, by the source device, a media stream including the rendered frame and the metadata to the client device.

The method of FIG. 2 also represents an example of a method of retrieving media data, including: receiving, by a streaming unit of a client device that also executes a media application, a rendered frame of media data from a source device in a media stream; receiving, by the streaming unit of the client device, system metadata to be passed to the media application, wherein the metadata is included in the media stream; and providing, by the streaming unit of the client device, the rendered frame and the system metadata to the media application.

The method of FIG. 2 further represents an example of a method of rendering media data, the method including: receiving, by a source device, data representing a user pose for which to render media data from a client device; rendering, by the source device, a rendered frame of media data according to the user pose; generating, by the source device, system metadata to be passed to a media application, the system metadata including pose data representing the user pose; and sending, by the source device, a media stream including the rendered frame and the metadata to the client device.

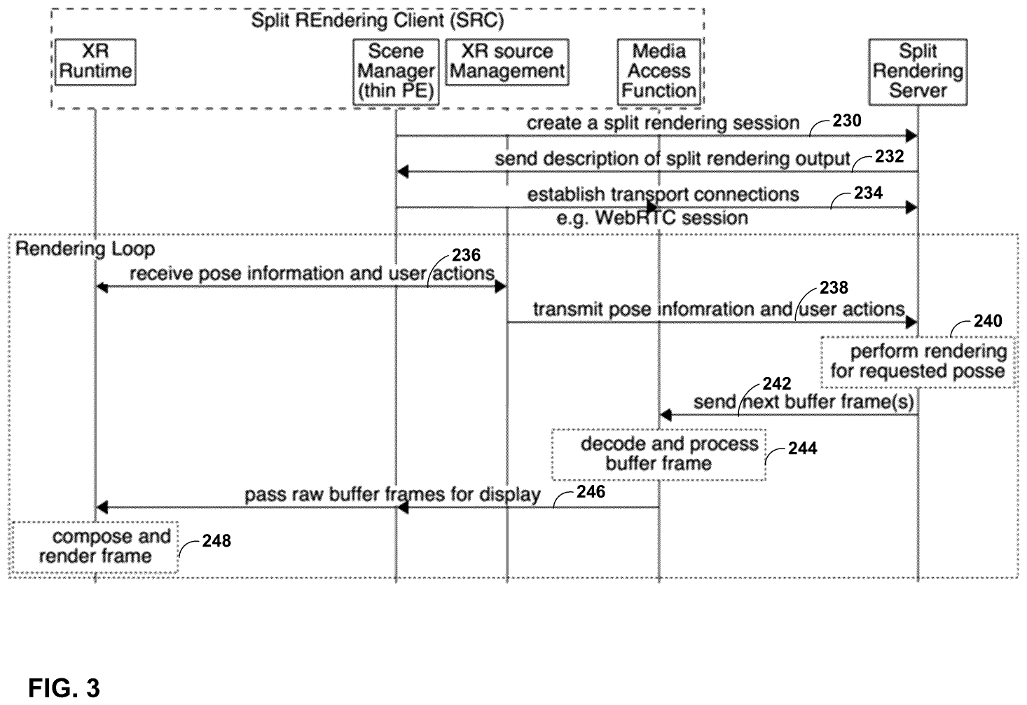

FIG. 3 is a call flow diagram illustrating an example of split rendering that may be performed by system 100 of FIG. 1. FIG. 3 includes an XR runtime, which may include a media application configured to present XR media data, as well as a media access function that may be executed by a streaming unit. In FIG. 3, the call flow includes creating a split rendering session (230), sending a description of split rendering output (232), and establishing transport connections (e.g., a WebRTC session) (234). Once this session has been established, during the session, XR client device 140 may receive and determine pose information and user actions (236) and transmit the pose information and user actions to XR server device 110 (238). XR server device 110 may then perform rendering for the requested pose (240) and send the rendered frame to XR client device 140 (242). XR client device 140 may decode and process the frame (244). XR client device 140 may then pass the raw frames to be displayed (246), and then compose and render the frame (248), which may include, per the techniques of this disclosure, modifying the rendered frame according to differences between the pose for which the frame was rendered as indicated by pose metadata and the actual user pose at the time the frame is to be presented.

In general, users desire realistic and high-fidelity immersive experiences in gaming, entertainment, and communication applications and services. At the same time, more and more users are relying on mobile and portable devices and head-mounted displays (HMDs) for consuming these services. Development of various XR systems may accelerate these trends and culminate the emergence of advanced and lightweight glasses and HMDs.

These two concurrent trends result in challenges for managing the processing power and battery life on these devices. Immersive high-fidelity experiences require immense graphics processing resources that come with high power consumption, which cannot be reconciliated with the capabilities and design goals of the XR devices/glasses.

Split rendering has been identified as a promising approach to address these challenges. With split rendering, the rendering process or parts thereof may be performed in the edge (e.g., by XR server device 110), supported by a reliable and optimized network, such as a 5G network. One configuration of split rendering is the so-called Pixel Streaming. In Pixel Streaming, the edge server receives the configuration of the XR session on the device, renders (off-screen) the audio and video of the 3D scene, and streams the rendered media on the downlink to the device. The device can use OpenXR or a similar XR runtime system to display/render the pre-rendered media.

OpenXR is an application programming interface (API) developed by the Khronos Group for developing XR applications that address a wide range of XR devices. XR refers to a mix of real and virtual world environments that are generated by computers through interactions by humans. XR includes technologies such as virtual reality (VR), augmented reality (AR) and mixed reality (MR). OpenXR is the interface between an application and XR runtime. The runtime handles functionality such as frame composition, user-triggered actions, and tracking information.

OpenXR is designed to be a layered API, which means that a user or application may insert API layers between the application and the runtime implementation. These API layers provide additional functionality by intercepting OpenXR functions from the layer above and then performing different operations than would otherwise be performed without the layer. In the simplest cases, the layer simply calls the next layer down with the same arguments, but a more complex layer may implement API functionality that is not present in the layers or runtime below it. This mechanism is essentially an architected “function shimming” or “intercept” feature that is designed into OpenXR and meant to replace more informal methods of “hooking” API calls.

Applications may determine the API layers that are available to them by calling the xrEnumerateApiLayerProperties function to obtain a list of available API layers. Applications then may select the desired API layers from this list and provide them to the xrCreateInstance function when creating an instance.

API layers may implement OpenXR functions that may or may not be supported by the underlying runtime. In order to expose these new features, the API layer may expose this functionality in the form of an OpenXR extension. The API layer need not expose new OpenXR functions without an associated extension.

An OpenXR instance is an object that allows an OpenXR application to communicate with an OpenXR runtime. The application may accomplish this communication by calling xrCreateInstance and receiving a handle to the resulting XrInstance object.

The XrInstance object stores and tracks OpenXR-related application state, without storing any such state in the application's global address space. This allows the application to create multiple instances as well as safely encapsulate the application's OpenXR state since this object is opaque to the application. OpenXR runtimes may limit the number of simultaneous XrInstance objects that may be created and used, but they must support the creation and usage of at least one XrInstance object per process.

Spaces are represented by XrSpace handles, which the application creates and then uses in API calls. Whenever an application calls a function that returns coordinates, it provides an XrSpace to specify the frame of reference in which those coordinates will be expressed. Similarly, when providing coordinates to a function, the application specifies which XrSpace the runtime to be used to interpret those coordinates.

OpenXR defines a set of well-known reference spaces that applications use to bootstrap their spatial reasoning. These reference spaces include: VIEW, LOCAL, and STAGE. Each reference space has a well-defined meaning, which establishes where its origin is positioned and how its axes are oriented.

Runtimes whose tracking systems improve their understanding of the world over time may track spaces independently. For example, even though a LOCAL space and a STAGE space each map their origin to a static position in the world, a runtime with an inside-out tracking system may introduce slight adjustments to the origin of each space on a continuous basis to keep each origin in place.

Beyond the well-known reference spaces, runtimes expose other independently tracked spaces, such as a pose action space that tracks the pose of a motion controller over time.

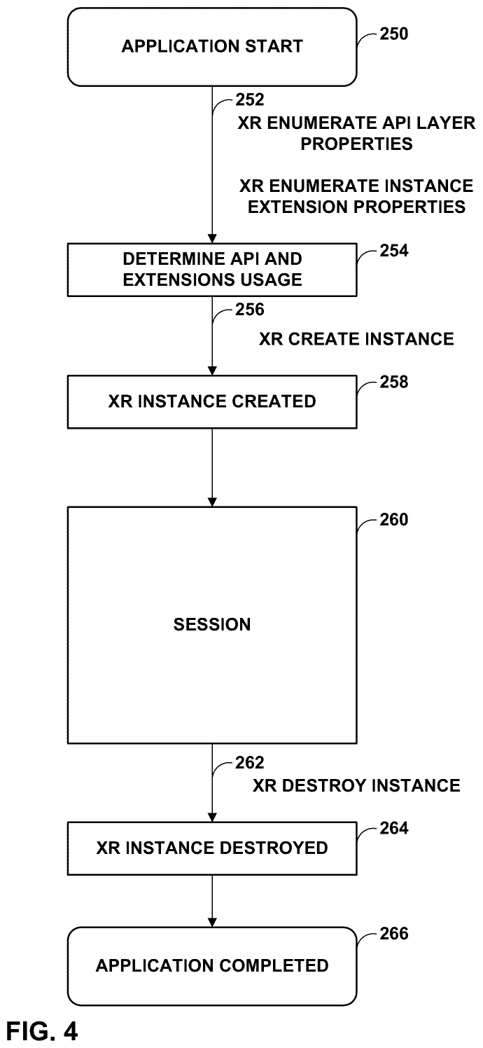

FIGS. 4-6 are conceptual diagrams illustrating an example lifecycle of an application that uses OpenXR for interaction and rendering with/to an HMD. FIG. 4 is a flow diagram illustrating an example process for creating and destroying an extended reality (XR) split rendering session between a split rendering server and a display device, such as a head mounted display (HMD). Augmented reality (AR) data may be formatted according to OpenXR. OpenXR is an API developed by the Khronos Group for developing XR applications that addresses a wide range of XR devices. XR refers to a mix of real and virtual world environments that are generated by computers through interactions by humans. XR includes technologies such as virtual reality (VR), augmented reality (AR), and mixed reality (MR). OpenXR acts as an interface between an application and an XR runtime. The XR runtime handles functionality such as frame composition, user-triggered actions, and tracking information.

OpenXR is designed to be a layered API, which means that a user or application may insert API layers between the application and the runtime implementation. These API layers provide additional functionality by intercepting OpenXR functions from the layer above and then performing different operations than would otherwise be performed without the layer. In the simplest cases, one layer simply calls the next layer down with the same arguments, but a more complex layer may implement API functionality that is not present in the layers or runtime below it. This mechanism is essentially an architected “function shimming” or “intercept” feature that is designed into OpenXR and meant to replace more informal methods of “hooking” API calls.

Initially, an XR application may start (250) and determine API layers that are available by calling an xrEnumerateApiLayerProperties function (252) of OpenXR to obtain a list of available API layers. The XR application may then select the desired API layers from this list (254) and provide the selected API layers to an xrCreateInstance function when creating an instance (256).

API layers may implement OpenXR functions that may or may not be supported by the underlying runtime. In order to expose these new features, the API layer must expose this functionality in the form of an OpenXR extension. The API layer must not expose new OpenXR functions without an associated extension. This may result in the OpenXR instance being created (258).

The XR application may then perform an XR session (260), during which media data may be received and presented to a user. An HMD or other device may track the user's position and orientation and generate pose information representing the position and orientation. Based on a current position and orientation, as well as velocity and rotation, the HMD may attempt to predict the position of the user at a future time. The HMD may send data representing a prediction of the user's future position and orientation to a split rendering server. The split rendering server may then at least partially render one or more images based on the prediction. The split rendering server may then send the at least partially rendered images to the HMD, along with information indicating the pose (position and orientation) for which the images were rendered. The HMD may then determine an actual pose and modify the received images according to differences between the predicted pose and the actual pose, then present the images to the user.

An OpenXR instance is an object that allows an OpenXR application to communicate with an OpenXR runtime. The application accomplishes this communication by calling xrCreateInstance and receiving a handle to the resulting XrInstance object.

The XrInstance object stores and tracks OpenXR-related application state, without storing any such state in the application's global address space. This allows the application to create multiple instances as well as safely encapsulate the application's OpenXR state, since this object is opaque to the application. OpenXR runtimes may limit the number of simultaneous XrInstance objects that may be created and used, but they must support the creation and usage of at least one XrInstance object per process.

Spaces are represented by XrSpace handles, which the XR application creates and then uses in API calls. Whenever an XR application calls a function that returns coordinates, the XR application provides an XrSpace to specify the frame of reference in which those coordinates will be expressed. Similarly, when providing coordinates to a function, the application specifies which XrSpace the runtime to be used to interpret those coordinates.

OpenXR defines a set of well-known reference spaces that applications use to bootstrap their spatial reasoning. These reference spaces are: VIEW, LOCAL and STAGE. Each reference space has a well-defined meaning, which establishes where its origin is positioned and how its axes are oriented.

Runtimes whose tracking systems improve their understanding of the world over time may track spaces independently. For example, even though a LOCAL space and a STAGE space each map their origin to a static position in the world, a runtime with an inside-out tracking system may introduce slight adjustments to the origin of each space on a continuous basis to keep each origin in place.

Beyond these reference spaces, runtimes may expose other independently tracked spaces, such as a pose action space that tracks the pose of a motion controller over time.

Once the XR session has ended, the XR application may destroy the XR instance (262), resulting in the XR instance being destroyed (264), and the XR application may then be completed (266).

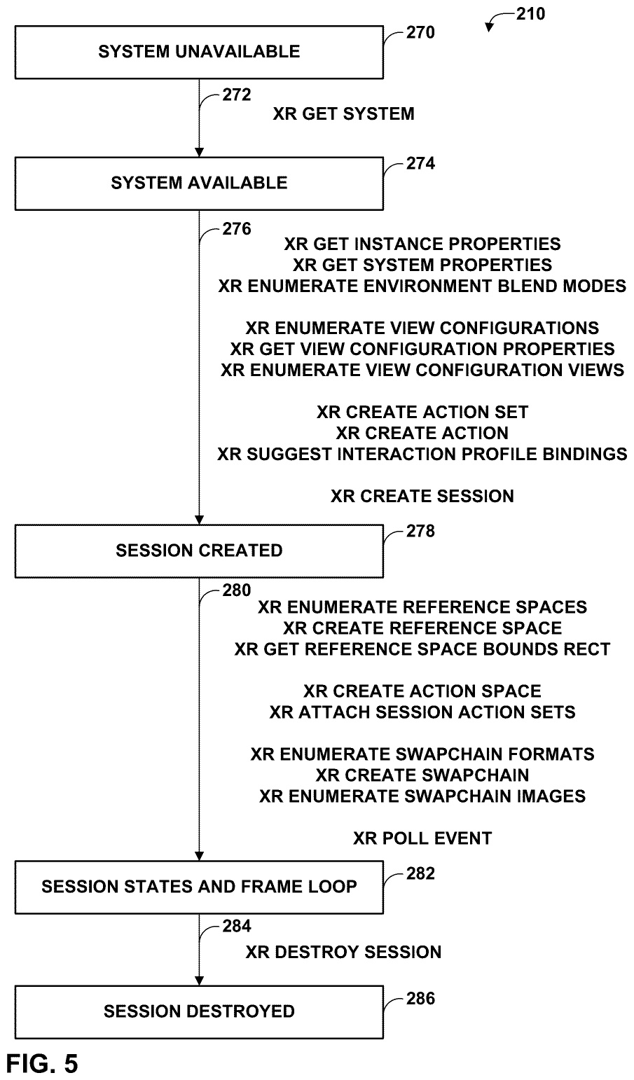

FIG. 5 is a flow diagram illustrating an example process performed during an XR split rendering session as explained with respect to FIG. 4. Initially, the system is unavailable (270). The XR application calls XR get system (272), and the system becomes available (274). The XR application may then perform a variety of calls to create the session (276), including obtaining instance properties, system properties, and enumerating environment blend modes, and enumerating view configurations using view configuration properties and enumerated view configuration views. The XR application may then create an action set and an action (e.g., when a user moves or turns) and suggests interaction profile blending. The session may then be created (278).

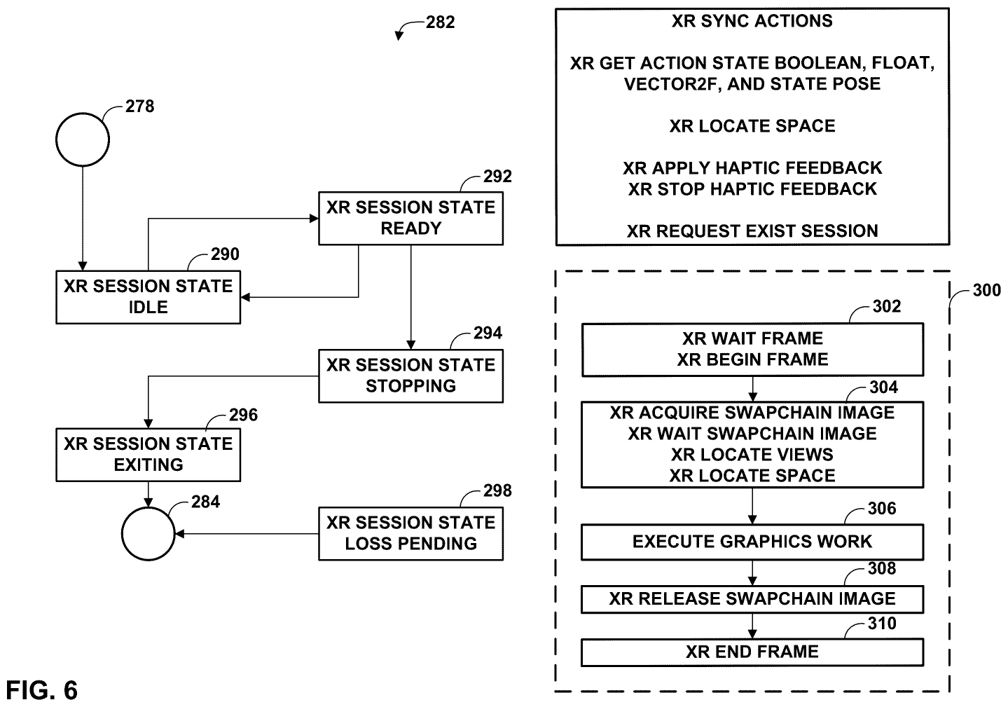

After the session is created, the XR application may enumerate reference spaces, create a reference space, get the reference space bounding rectangle, create an action space, attach session action sets, enumerate swapchain formats, create swapchains, enumerate swapchain events, and create a poll event (280). The session may then traverse various session states and enter a frame loop (282) as explained with respect to FIG. 6 below. Once the session is terminated (284), the XR application may destroy the session (286).

FIG. 6 is a flow diagram illustrating an example set of session states and processing operations performed during an XR split session as explained with respect to FIGS. 5 and 6. Initially, an XR session may begin in an XR session state idle (290), then transition to XR session state ready (292). During the ready state, method 300 may be performed as explained below. The state may then transition back to XR session state idle if the session is continuing, or to XR session state stopping (294) if the session is to be terminated. In the stopping state, the XR application may tear down communication sessions for the XR session, then transition to XR session state exiting (296). Alternatively, if there is loss, the XR session state loss pending (298) may also terminate the session.

In method 250, an XR application calls the XR wait frame function to wait for the opportunity to display the next frame. Once the call returns, it informs the XR runtime that it is to start rendering swapchain images by calling the xrBeginFrame (302). The XR application calls the xrAcquireSwapchainImage or the xrWaitSwapchinImage (304) to get exclusive access to the swapchain images for rendering. The XR application then uses a graphics engine of its choice, such as Vulkan or OpenGL, to render the scene (306). Once done, the XR application releases the swapchain images by calling the xrReleaseSwapchainImage (308) and passing the rendered frame to the XR runtime through a call to xrEndFrame (310).

For split rendering, the graphics work of step 256 is performed completely or partially in the edge application server. Instead of sending the current pose and waiting for a response from the edge, the XR application would send a predicted pose some time in the future and render the frame that was last received from the edge. The XR application would then receive a rendered image for the predicted pose from the edge application server, along with data representing the predicted pose.

After creating an OpenXR session, e.g., per the techniques shown in FIGS. 4-6, the application starts a frame loop. The frame loop may be executed for every frame. The frame loop may include the following steps:
Synchronize actions: this step includes retrieving the action state, e.g., the status of controller buttons and associated pose. During this step, the application may also establish the location of different trackables (e.g., HMD, controllers, body positioning units, or the like). The application may also send haptics feedback to the user (e.g., controller vibrations).
Start a new frame: this step may begin with waiting for a frame to be provided by the XR runtime. This step may be performed to synchronize the application frame submission with the display. The xrWaitFrame function returns a frame state for the requested frame that includes a predictedDisplayTime, which is a prediction of when the corresponding composited frame will be displayed. This information is used by the application to request the predicted pose at the display. Once the xrWaitFrame function completes, the application calls xrBeginFrame to signal the start of the rendering process.
Retrieve rendering resources: the application starts by locating the views in space and time by calling the xrLocate Views function, provided with the predicted display time and the XR space. The application then acquires the swap chain image associated with every view of the composition layer. The application waits for the swap chain image to be made available so it can write into the swap chain image.
Rendering: the application then performs its rendering work. This is for instance what the scene manager is tasked with. It iterates over the scene graph nodes and renders each object to the view. This step usually uses a Graphics Framework such Vulkan, OpenGL, or Direct3D to perform the actual graphics operations.
Release resources: once the rendering is done for a view, the application releases the corresponding swap chain image. Once all views are rendered, the application sends the view images for display by calling the xrEndFrame function.

In terms of rendering operations, the relevant part is located between the call to xrBeginFrame and the call to xrEndFrame on the bottom right part of FIG. 6.

When the application calls the xrEndFrame function, the application provides the structure XrFrameEndInfo, which contains all necessary information to render the frame that is: the time at which this frame should be displayed, the mode to be used for blending the user's environment with the submitted frame, and one or more layers which compose the submitted frame, where each composition layer provides the XR space, pose, fov, and the corresponding swapchain image(s).

An important feature of the XR runtime is its ability to perform layer composition. A compositor in the runtime is responsible for taking all the received layers from xrEndFrame calls, performing any necessary corrections, such as pose correction and lens distortion, compositing them, and then sending the final frame to the display. An application may use multiple composition layers for its rendering. The number of supported composition layers may be queried by the application.

OpenXR supports different types of layers, with the main types being:
Projection Composition Layer: represents planar projected images, one rendered for each eye using a perspective projection.
Quad Composition Layer: is useful for rendering user interface elements or 2D content on a planar area in the world.
Cube Composition Layer: consists of a cube map with 6 views to be rendered by the application.
Equirectangular Composition Layer: consists of an equirectangular image that is mapped onto the inside of a sphere in the world.
Depth Composition Layer: provides an extra composition layer to allow applications to submit depth maps to assist with the pose correction of projected images of a project layer.

Another relevant configuration when setting up the XR session is the choice of the view configuration, which depends on the target device and its capabilities. Mono and Stereo are natively supported by all XR runtimes. Some advanced types, like the primary quad, defined as a vendor extension provide support for foveated rendering.

As discussed above, the XR runtime expects each rendered frame to be accompanied by a description of the pose that was used to render that frame. Other information, such as the field of view (FoV) and the XR space may be static and do not need to be sent with every frame. The XR runtime uses the pose information to perform any pose correction prior to display.

It can also be assumed that the audio renderer will perform similar pose correction prior to playing back the audio frame. Pose correction is important for split rendering, as the round-trip time from pose acquisition to displaying the rendered media on the device may be significant, given that the rendering happens in the network.

In addition to the pose, the Split Rendering Server may also provide a list of the actions that have been processed prior to the network rendering operation for a specific frame.

To carry this metadata, as discussed above, XR server device 110 of FIG. 1 may use in-band carriage to XR client device 140 of FIG. 1. The format, syntax, and semantics for this in-band carriage of the metadata may be as shown in and discussed with respect to Table 1 above.

The following clauses represent certain examples of the techniques of this disclosure:
Clause 1: A method of rendering media data, the method comprising: receiving, by a client device, a rendered frame of media data from a source device in a media stream; receiving, by the client device, metadata representing a pose of a user for which the frame of media data was rendered, wherein the metadata is included in the media stream; modifying, by the client device, the rendered frame according to an actual pose of the user to form a modified rendered frame; and presenting, by the client device, the modified rendered frame to the user.
Clause 2: The method of clause 1, wherein receiving the metadata comprises receiving a set of metadata including one or more of an indication of whether a list of actions is present, a wallclock timestamp for the pose of the user, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.
Clause 3: The method of any of clauses 1 and 2, wherein receiving the metadata comprises receiving a set of metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.
Clause 4: The method of any of clauses 1-3, wherein receiving the metadata includes receiving at least a portion of the metadata in a supplemental enhancement information (SEI) message.
Clause 5: The method of any of clauses 1-4, wherein receiving the metadata includes receiving at least a portion of the metadata in an audio stream of the media stream associated with a video stream including the rendered frame.
Clause 6: The method of clause 5, wherein receiving the at least portion of the metadata in the audio stream includes receiving an MPEG-H audio stream (MHAS) packet including a payload type value indicating that the MHAS packet includes the at least portion of the metadata.
Clause 7: The method of clause 6, wherein the payload type value comprises PACTYP_XRRENDERPOSE.
Clause 8: The method of any of clauses 1-7, wherein receiving the metadata includes receiving at least a portion of the metadata as a watermark included in the rendered frame.
Clause 9: The method of any of clauses 1-8, further comprising receiving a session description protocol (SDP) attribute indicating that the metadata is included in the media stream.
Clause 10: The method of clause 9, further comprising registering for a metadata callback for one or more streams of the metadata stream that indicate the presence of the metadata.
Clause 11: The method of clause 1, wherein receiving the metadata comprises receiving a set of metadata including one or more of an indication of whether a list of actions is present, a wallclock timestamp for the pose of the user, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.
Clause 12: The method of clause 1, wherein receiving the metadata comprises receiving a set of metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.
Clause 13: The method of clause 1, wherein receiving the metadata includes receiving at least a portion of the metadata in a supplemental enhancement information (SEI) message.
Clause 14: The method of clause 1, wherein receiving the metadata includes receiving at least a portion of the metadata in an audio stream of the media stream associated with a video stream including the rendered frame.
Clause 15: The method of clause 14, wherein receiving the at least portion of the metadata in the audio stream includes receiving an MPEG-H audio stream (MHAS) packet including a payload type value indicating that the MHAS packet includes the at least portion of the metadata.
Clause 16: The method of clause 15, wherein the payload type value comprises PACTYP_XRRENDERPOSE.
Clause 17: The method of clause 1, wherein receiving the metadata includes receiving at least a portion of the metadata as a watermark included in the rendered frame.
Clause 18: The method of clause 1, further comprising receiving a session description protocol (SDP) attribute indicating that the metadata is included in the media stream.
Clause 19: The method of clause 18, further comprising registering for a metadata callback for one or more streams of the metadata stream that indicate the presence of the metadata.
Clause 20: A method of rendering media data, the method comprising: receiving, by a source device, data representing a user pose for which to render media data from a client device; rendering, by the source device, a rendered frame of media data according to the user pose; generating, by the source device, metadata representing the user pose; and sending, by the source device, a media stream including the rendered frame and the metadata to the client device.
Clause 21: The method of clause 20, wherein generating the metadata comprises generating a set of metadata including one or more of an indication of whether a list of actions is present, a wallclock timestamp for the pose of the user, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.
Clause 22: The method of any of clauses 20 and 21, wherein generating the metadata comprises generating a set of metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.
Clause 23: The method of any of clauses 20-22, wherein generating the metadata includes generating a supplemental enhancement information (SEI) message including at least a portion of the metadata.
Clause 24: The method of any of clauses 20-23, wherein generating the metadata includes generating an audio stream of the media stream associated with a video stream including the rendered frame, the audio stream including at least a portion of the metadata.
Clause 25: The method of clause 24, wherein generating audio stream including the at least portion of the metadata includes generating an MPEG-H audio stream (MHAS) packet including a payload type value indicating that the MHAS packet includes the at least portion of the metadata.
Clause 26: The method of clause 25, wherein the payload type value comprises PACTYP_XRRENDERPOSE.
Clause 27: The method of any of clauses 20-26, wherein generating the metadata includes modifying the rendered frame to include at least a portion of the metadata as a watermark in the rendered frame.
Clause 28: The method of any of clauses 20-27, further comprising sending a session description protocol (SDP) attribute indicating that the metadata is included in the media stream to the client device.
Clause 29: The method of clause 20, wherein generating the metadata comprises generating a set of metadata including one or more of an indication of whether a list of actions is present, a wallclock timestamp for the pose of the user, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.
Clause 30: The method of clause 20, wherein generating the metadata comprises generating a set of metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax clement, an actions_count syntax element, or an xrpi_action_id syntax element.

Clause 31: The method of clause 20, wherein generating the metadata includes generating a supplemental enhancement information (SEI) message including at least a portion of the metadata.
Clause 32: The method of clause 20, wherein generating the metadata includes generating an audio stream of the media stream associated with a video stream including the rendered frame, the audio stream including at least a portion of the metadata.
Clause 33: The method of clause 32, wherein generating the audio stream including the at least portion of the metadata includes generating an MPEG-H audio stream (MHAS) packet including a payload type value indicating that the MHAS packet includes the at least portion of the metadata.
Clause 34: The method of clause 25, wherein the payload type value comprises PACTYP_XRRENDERPOSE.
Clause 35: The method of clause 20, wherein generating the metadata includes modifying the rendered frame to include at least a portion of the metadata as a watermark in the rendered frame.
Clause 36: The method of clause 20, further comprising sending a session description protocol (SDP) attribute indicating that the metadata is included in the media stream to the client device.
Clause 37: A device for rendering media data, the device comprising one or more means for performing the method of any of clauses 1-36.
Clause 38: The device of clause 37, wherein the one or more means comprise a processing system comprising one or more processors implemented in circuitry.
Clause 39: The device of clause 37, wherein the apparatus comprises at least one of: an integrated circuit; a microprocessor; and a wireless communication device.
Clause 40: A computer-readable storage medium having stored thereon instructions that, when executed, cause a processing system to perform the method of any of clauses 1-36.
Clause 41: A client device for rendering media data, the client device comprising: means for receiving a rendered frame of media data from a source device in a media stream; means for receiving metadata representing a pose of a user for which the frame of media data was rendered, wherein the metadata is included in the media stream; means for modifying the rendered frame according to an actual pose of the user to form a modified rendered frame; and means for presenting the modified rendered frame to the user.
Clause 42: A source device for rendering media data, the source device comprising: means for receiving data representing a user pose for which to render media data from a client device; means for rendering a rendered frame of media data according to the user pose; means for generating metadata representing the user pose; and means for sending a media stream including the rendered frame and the metadata to the client device.
Clause 43: A method of retrieving media data, the method comprising: receiving, by a streaming unit of a client device that also executes a media application, a rendered frame of media data from a source device in a media stream; receiving, by the streaming unit of the client device, system metadata to be passed to the media application, wherein the metadata is included in the media stream; and providing, by the streaming unit of the client device, the rendered frame and the system metadata to the media application.
Clause 44: The method of clause 43, wherein receiving the system metadata comprises receiving a set of system metadata including one or more of an indication of whether a list of actions is present, a wallclock timestamp for a pose of the user for which the rendered frame of media data was rendered, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.
Clause 45: The method of clause 43, wherein receiving the system metadata comprises receiving a set of system metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.
Clause 46: The method of clause 43, wherein receiving the system metadata includes receiving at least a portion of the system metadata in a supplemental enhancement information (SEI) message.
Clause 47: The method of clause 43, wherein receiving the system metadata includes receiving at least a portion of the system metadata in an audio stream of the media stream associated with a video stream including the rendered frame.
Clause 48: The method of clause 47, wherein receiving the at least portion of the system metadata in the audio stream includes receiving an MPEG-H audio stream (MHAS) packet including a payload type value indicating that the MHAS packet includes the at least portion of the metadata.
Clause 49: The method of clause 48, wherein the payload type value comprises PACTYP_XRRENDERPOSE.
Clause 50: The method of clause 43, wherein the system metadata includes a pose of a user for which the frame of media data was rendered, the method further comprising modifying, by the client device, the rendered frame according to an actual pose of the user to form a modified rendered frame, wherein presenting the frame comprises presenting the modified rendered frame.
Clause 51: The method of clause 43, wherein receiving the system metadata includes receiving at least a portion of the system metadata as a watermark included in the rendered frame.
Clause 52: The method of clause 43, further comprising receiving a session description protocol (SDP) attribute indicating that the system metadata is included in the media stream.
Clause 53: The method of clause 52, further comprising registering for a metadata callback for one or more streams of the metadata stream that indicate the presence of the metadata.
Clause 54: A device for retrieving media data, the device comprising: a memory configured to store media data; and a processing system comprising one or more processors implemented in circuitry, the processing system being configured to execute a media application, and configured to execute a streaming unit to: receive a rendered frame of media data from a source device in a media stream; receive system metadata to be passed to the media application, wherein the metadata is included in the media stream; and provide the rendered frame and the system metadata to the media application.
Clause 55: A method of rendering media data, the method comprising: receiving, by a source device, data representing a user pose for which to render media data from a client device; rendering, by the source device, a rendered frame of media data according to the user pose; generating, by the source device, system metadata to be passed to a media application, the system metadata including pose data representing the user pose; and sending, by the source device, a media stream including the rendered frame and the metadata to the client device.
Clause 56: The method of clause 55, wherein generating the system metadata comprises generating a set of system metadata including one or more of an indication of whether a list of actions is present, a wallclock timestamp for the pose of the user, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.
Clause 57: The method of clause 55, wherein generating the system metadata comprises generating a set of system metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.
Clause 58: The method of clause 55, wherein generating the system metadata includes generating a supplemental enhancement information (SEI) message including at least a portion of the system metadata.
Clause 59: The method of clause 55, wherein generating the system metadata includes generating an audio stream of the media stream associated with a video stream including the rendered frame, the audio stream including at least a portion of the metadata.
Clause 60: The method of clause 59, wherein generating the audio stream including the at least portion of the metadata includes generating an MPEG-H audio stream (MHAS) packet including a payload type value indicating that the MHAS packet includes the at least portion of the metadata.
Clause 61: The method of clause 55, further comprising sending a session description protocol (SDP) attribute indicating that the metadata is included in the media stream to the client device.
Clause 62: A device for rendering media data, the device comprising: a memory configured to store media data; and a processing system comprising one or more processors implemented in circuitry, the processing system being configured to: receive data representing a user pose for which to render media data from a client device; render a rendered frame of media data according to the user pose; generate system metadata to be passed to a media application, the system metadata including pose data representing the user pose; and send a media stream including the rendered frame and the metadata to the client device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
receiving, by a streaming unit of a client device that also executes a media application, a rendered frame of media data from a source device in a media stream;
receiving, by the streaming unit of the client device, system metadata to be passed to the media application, wherein the metadata is included in the media stream; and
providing, by the streaming unit of the client device, the rendered frame and the system metadata to the media application.

2. The method of claim 1, wherein the system metadata represents split rendering data for the media application, the split rendering data including a timestamp for the rendered frame, a rendered pose for the rendered frame, and one or more previously executed rendering operations for the rendered frame.

3. The method of claim 1, wherein receiving the system metadata comprises receiving a set of system metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.

4. The method of claim 1, wherein receiving the system metadata includes receiving at least a portion of the system metadata in a supplemental enhancement information (SEI) message.

5. The method of claim 1, wherein receiving the system metadata includes receiving at least a portion of the system metadata in an audio stream of the media stream associated with a video stream including the rendered frame.

6. The method of claim 5, wherein receiving the at least portion of the system metadata in the audio stream includes receiving an MPEG-H audio stream (MHAS) packet including a payload type value indicating that the MHAS packet includes the at least portion of the metadata.

7. The method of claim 6, wherein the payload type value comprises PACTYP_XRRENDERPOSE.

8. The method of claim 1, wherein the system metadata includes a pose of a user for which the frame of media data was rendered, the method further comprising modifying, by the client device, the rendered frame according to an actual pose of the user to form a modified rendered frame, wherein presenting the frame comprises presenting the modified rendered frame.

9. The method of claim 1, wherein receiving the system metadata includes receiving at least a portion of the system metadata as a watermark included in the rendered frame.

10. The method of claim 1, further comprising receiving a session description protocol (SDP) attribute indicating that the system metadata is included in the media stream.

11. The method of claim 10, further comprising registering for a metadata callback for one or more streams of the metadata stream that indicate the presence of the metadata.

12. A device for retrieving media data, the device comprising:
a memory configured to store media data; and
a processing system comprising one or more processors implemented in circuitry, the processing system being configured to execute a media application, and configured to execute a streaming unit to:
receive a rendered frame of media data from a source device in a media stream;
receive system metadata to be passed to the media application, wherein the metadata is included in the media stream; and
provide the rendered frame and the system metadata to the media application.

13. A method of rendering media data, the method comprising:
receiving, by a source device, data representing a user pose for which to render media data from a client device;
rendering, by the source device, a rendered frame of media data according to the user pose;
generating, by the source device, system metadata to be passed to a media application, the system metadata including pose data representing the user pose; and
sending, by the source device, a media stream including the rendered frame and the metadata to the client device.

14. The method of claim 13, wherein generating the system metadata comprises generating a set of system metadata including one or more of an indication of whether a list of actions is present, a wallclock timestamp for the pose of the user, coordinates of a position of the pose of the user, components of a quaternion representing a rotation of the pose of the user, a number of the actions processed prior to rendering the frame with the pose of the user, or an identifier of an action that was processed prior to rendering the frame with the pose of the user.

15. The method of claim 13, wherein generating the system metadata comprises generating a set of system metadata including one or more of an xrpi_actions_present syntax element, an xrpi_reserved syntax element, an xrpi_timestamp syntax element, an xrpi_x syntax element, an xrpi_y syntax element, an xrpi_z syntax element, an xrpi_rx syntax element, an xrpi_ry syntax element, an xrpi_rz syntax element, an xrpi_rw syntax element, an actions_count syntax element, or an xrpi_action_id syntax element.

16. The method of claim 13, wherein generating the system metadata includes generating a supplemental enhancement information (SEI) message including at least a portion of the system metadata.

17. The method of claim 13, wherein generating the system metadata includes generating an audio stream of the media stream associated with a video stream including the rendered frame, the audio stream including at least a portion of the metadata.

18. The method of claim 17, wherein generating the audio stream including the at least portion of the metadata includes generating an MPEG-H audio stream (MHAS) packet including a payload type value indicating that the MHAS packet includes the at least portion of the metadata.

19. The method of claim 13, further comprising sending a session description protocol (SDP) attribute indicating that the metadata is included in the media stream to the client device.

20. A device for rendering media data, the device comprising:
a memory configured to store media data; and
a processing system comprising one or more processors implemented in circuitry, the processing system being configured to:
receive data representing a user pose for which to render media data from a client device;
render a rendered frame of media data according to the user pose;
generate system metadata to be passed to a media application, the system metadata including pose data representing the user pose; and
send a media stream including the rendered frame and the metadata to the client device.
